(19) United States
(12) Patent Application Publication
(10) Pub. No.: US 2022/0400080 A1
(43) Pub. Date: Dec. 15, 2022

(54) PACKET PROCESSING APPARATUS AND PACKET PROCESSING METHOD

(71) Applicant: FUJITSU LIMITED, Kawasaki-shi (JP)

(72) Inventor: Nagao SHIMADA, Setagaya (JP)

(73) Assignee: FUJITSU LIMITED, Kawasaki-shi (JP)

(21) Appl. No.: 17/672,801

(22) Filed: Feb. 16, 2022

(30) Foreign Application Priority Data
Jun. 11, 2021 (JP) 2021-097898

(51) Int. Cl. H04L 47/24; H04L 47/41

(52) U.S. Cl. CPC H04L 47/24; H04L 47/41

(57) ABSTRACT

A packet processing apparatus includes: a plurality of storages configured to store packets for each high priority flow or low priority flow for each output port in the same group; a gate configured to open and close output of each storage; and a processor configured to: control opening and closing of the gate to preferentially output high priority packets of the high priority flow on the basis of gate information that controls the gate; calculate, for each output port, the theoretical number of collisions of the high priority packets in which arrival timings overlap between the high priority packets; distribute a high priority flow of a collision to another output port in the same group by a link aggregation scheme such that the theoretical number of collisions is reduced; and update contents of the gate information based on distribution contents.

### CROSS-REFERENCE TO RELATED APPLICATION

This application is based upon and claims the benefit of priority of the prior Japanese Patent Application No. 2021-97898, filed on Jun. 11, 2021, the entire contents of which are incorporated herein by reference.

### FIELD

The embodiments discussed herein are related to a packet processing apparatus and a packet processing method.

### BACKGROUND

For example, a fifth generation mobile communication (5G) network includes, for example, a radio antenna station such as a distributed unit (DU) or a remote radio head (RRH) and, for example, a base station device such as a central unit (CU) or a baseband unit (BBU). The 5G network includes a mobile front haul (MFH) line set between the radio antenna station and the base station device and a mobile back haul (MBH) line set between the base station device and a metro core network.

Japanese Laid-open Patent Publication No. 2020-162032, Japanese Laid-open Patent Publication No. 2020-195020, and Japanese Laid-open Patent Publication No. 2020-48045 are disclosed as related art.

### SUMMARY

According to an aspect of the embodiments, a packet processing apparatus includes: a plurality of storages configured to store packets for each high priority flow or low priority flow for each output port in the same group; a gate configured to open and close output of each storage; and a processor configured to: control opening and closing of the gate to preferentially output high priority packets of the high priority flow on the basis of gate information that controls the gate; calculate, for each output port, the theoretical number of collisions of the high priority packets in which arrival timings overlap between the high priority packets; distribute a high priority flow of a collision to another output port in the same group by a link aggregation scheme such that the theoretical number of collisions is reduced; and update contents of the gate information based on distribution contents.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a communication system of a first embodiment;

FIG. 2 is an explanatory diagram illustrating an example of a configuration of a packet processing apparatus of the first embodiment;

FIG. 3 is an explanatory diagram illustrating an example of a configuration of a collision control unit;

FIG. 4 is an explanatory diagram illustrating an example of statistical information regarding a high priority flow;

FIG. 5 is an explanatory diagram illustrating an example of a periodicity pattern of the high priority flow;

FIG. 6 is an explanatory diagram illustrating an example of table contents of a port distribution table;

FIG. 7 is an explanatory diagram illustrating an example of the theoretical number of collisions per output port;

FIG. 8 is an explanatory diagram illustrating an example of port distribution based on a hash calculation result;

FIG. 9 is an explanatory diagram illustrating an example of the theoretical number of collisions at each output port after the distribution;

FIG. 10 is an explanatory diagram illustrating an example of a gate control list (GCL) of each output port reflecting distribution contents;

FIG. 11 is a flowchart illustrating an example of a processing operation of the packet processing apparatus related to first distribution processing;

FIG. 12 is an explanatory diagram illustrating an example of a problem of the packet processing apparatus of the first embodiment;

FIG. 13 is an explanatory diagram illustrating an example of a configuration of a packet processing apparatus of a second embodiment;

FIG. 14 is an explanatory diagram illustrating an example of a configuration of a collision control unit;

FIG. 15 is an explanatory diagram illustrating an example of the theoretical number of collisions per output port;

FIG. 16 is an explanatory diagram illustrating an example of the theoretical number of collisions at each output port after distribution;

FIG. 17 is an explanatory diagram illustrating an example of a GCL of each output port reflecting distribution contents;

FIG. 18 is an explanatory diagram illustrating an example of packet output of the packet processing apparatus of the second embodiment;

FIG. 19 is a flowchart illustrating an example of a processing operation of the packet processing apparatus related to second distribution processing; and

FIG. 20 is an explanatory diagram illustrating an example of collision delay occurrence in a known packet processing apparatus.

### DESCRIPTION OF EMBODIMENTS

The 5G network mixedly accommodates, for example, a high priority flow including a high priority packet such as an MFH packet including high real-time data such as voice and telemedicine communication data and a low priority flow including a low priority packet such as a non-MFH packet of data communication or the like. The MFH packet needs to have low delay of, for example, 0.25 milliseconds or less. Thus, a packet processing apparatus needs a priority control function for preferentially processing the MFH packet as compared with the non-MFH packet.

Therefore, for example, Time Sensitive Networking (TSN) by the Institute of Electrical and Electronics Engineers (IEEE) 802.1 is under consideration. As the TSN, a time aware shaper (TAS) scheme called IEEE 802.1Qbv is known as a data plane function to suppress output delay of packets.

According to the TAS technology, it is possible to control, on the basis of a gate control list (GCL), opening/closing of a gate provided for each class of packets. In the GCL, opening/closing of each gate is set for each time slot. Thus, in a case where the GCL is generated on the basis of a traffic pattern of the MFH packet, a layer 2 switch may preferentially forward the MFH packet.

Therefore, the TAS technology needs a mechanism to create a GCL that sets very sensitive gate opening/closing on the order of microseconds, and to maintain the GCL. Therefore, an intelligent TAS (iTAS) technology has been proposed in which a packet timing is acquired from a main signal, a packet processing apparatus autonomously learns a period, a phase, and the like, and a GCL is corrected.

The packet processing apparatus adopting the iTAS technology includes a plurality of storage units, an opening/closing unit, a collection unit, an analysis unit, and a control unit. The storage unit is a queue that stores a received packet for each type of a reception flow. Note that the types of the reception flow include a high priority flow and a low priority flow. The opening/closing unit is a gate that opens/closes output of each storage unit. The collection unit collects a packet amount for each time slot of a high priority flow. The analysis unit specifies a periodicity pattern of a high priority flow on the basis of a packet amount for each time slot of the high priority flow. The control unit specifies a time slot section in which a high priority flow is preferentially output on the basis of a periodicity pattern of the high priority flow specified by the analysis unit, and controls opening/closing of each opening/closing unit of the specified time slot section. As a result, output delay of a high priority flow may be suppressed by preferentially outputting the high priority flow.

However, in a known packet processing apparatus, for example, in a case where a plurality of input ports and a single output port are included and high priority flows are received from the plurality of input ports, there occurs a case where arrival timings of high priority packets of the high priority flows overlap. In a case where the arrival timings of the high priority packets overlap and the output port is the same, since only one high priority packet may be output from the single output port without delay, collision delay occurs in other high priority packets.

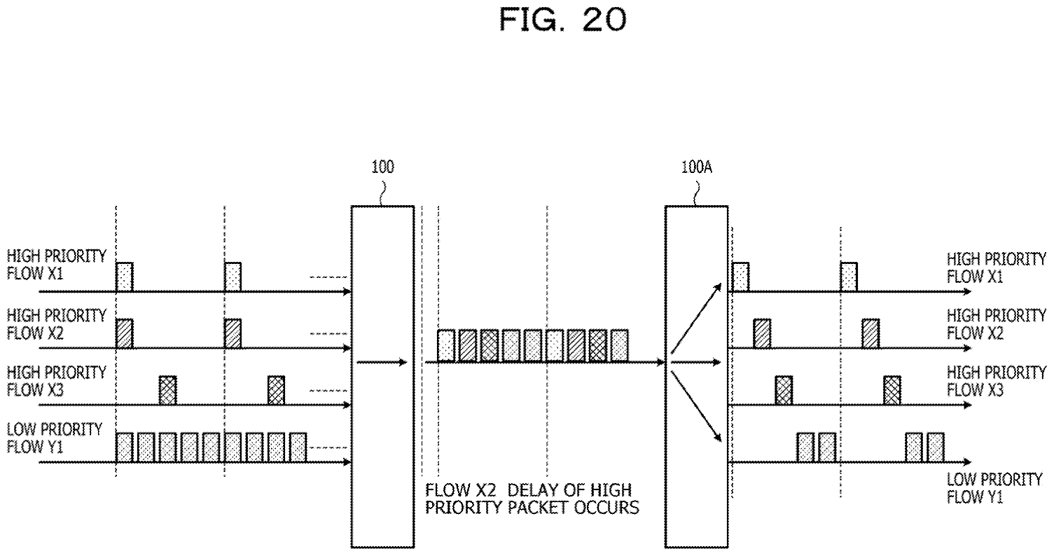

FIG. 20 is an explanatory diagram illustrating an example of collision delay occurrence in a known packet processing apparatus. A packet processing apparatus 100 illustrated in FIG. 20 includes four input ports and one output port. Moreover, the packet processing apparatus 100 outputs an output packet to an opposite apparatus 100A. In addition, the opposite apparatus 100A outputs the packet received from the packet processing apparatus 100 to each destination port according to a reception flow.

The input ports of the packet processing apparatus 100 include a first input port for inputting a high priority flow X1, a second input port for inputting a high priority flow X2, a third input port for inputting a high priority flow X3, and a fourth input port for inputting a low priority flow Y1.

Note that, for convenience of description, for example, high priority packets X1 and X2 and a low priority packet Y1 are input at a timing of a time slot (TS) “1”, and a low priority packet Y1 is input at a timing of a TS “2”. Moreover, a high priority packet X3 and the low priority packet Y1 are input at a timing of a TS “3”, the low priority packet Y1 is input at a timing of a TS “4”, and the low priority packet Y1 is input at a timing of a TS “5”. Moreover, the high priority packets X1 and X2 and the low priority packet Y1 are input at a timing of a TS “6”, the low priority packet Y1 is input at a timing of a TS “7”, and the high priority packet X3 and the low priority packet Y1 are input at a timing of a TS “8”. Moreover, it is assumed that the low priority packet Y1 is input at a timing of a TS “9”, and the input is performed in such an order.

The packet processing apparatus 100 sequentially performs output from the single output port in the order of X1→X2→X3→Y1→Y1→X1→X2→→X3→Y1→Y1 . . . , for example. As a result, the opposite apparatus 100A receives in the order of X1→X2→X3→Y1→Y1 →X1 →X2→X3 →Y1→Y1 . . . , for example, and sequentially performs output to each destination port according to the reception flow according to the reception order.

For example, in a case where arrival timings of the high priority flows X1 and X2 overlap at the timing of the TS “1”, since the output port is single, the packet processing apparatus 100 outputs the high priority packet X1 from the output port, and then outputs the high priority packet X2. As a result, collision delay occurs in the high priority packet X2. For example, when arrival timings of a plurality of high priority packets destined to the same port overlap, collision delay of the high priority packets occurs except for a packet output at the head.

In one aspect, it is an object to provide a packet processing apparatus and a packet processing method capable of suppressing collision delay of high priority packets even in a case where arrival timings of the high priority packets overlap.

Hereinafter, embodiments of a packet processing apparatus and a packet processing method disclosed in the present application will be described in detail with reference to the drawings. Note that the disclosed technology is not limited by each of the embodiments. Furthermore, each embodiment to be described below may be combined as appropriate, without causing inconsistency.

### First Embodiment

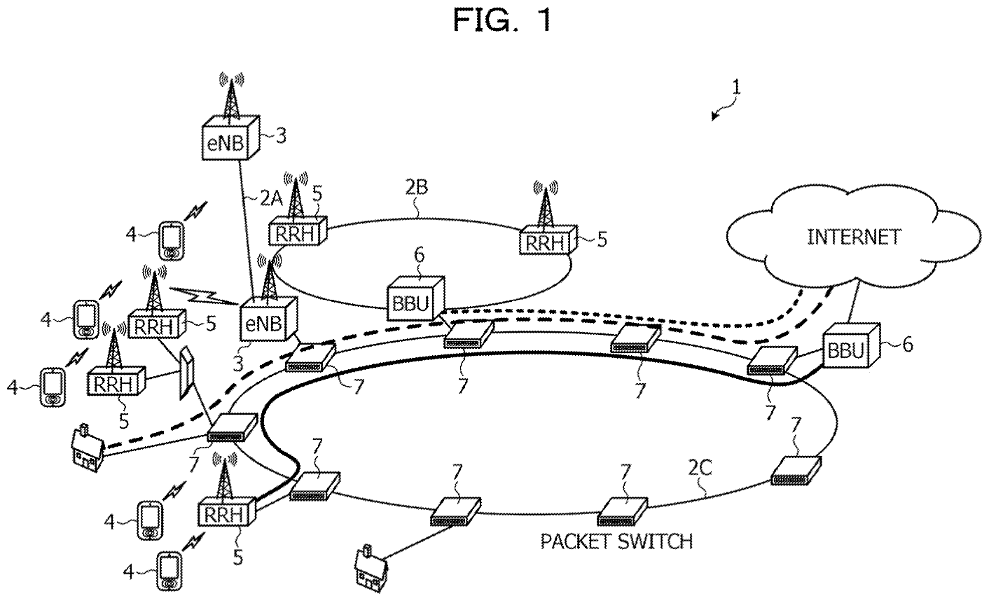

FIG. 1 is an explanatory diagram illustrating an example of a communication system 1 of a first embodiment. The communication system 1 illustrated in FIG. 1 includes a mobile back haul (MBH) line 2A, a mobile front haul (MFH) line 2B, and a backbone line 2C. The MBH line 2A is a line that connects a plurality of base stations (evolved Node B (eNB)) 3. The base stations 3 are wirelessly connected to radio terminals 4 through a radio antenna. The MFH line 2B is a line that connects between a remote radio head (RRH) 5 and a baseband unit (BBU) 6. The RRH 5 is wirelessly connected to the radio terminals 4. The MFH line 2B adopts a common public radio interface (CPRI) scheme in which radio signals are transmitted between the RRH 5 and the BBU 6 by using MFH packets of an L2 frame. The backbone line 2C connects not only to the MBH line 2A and the MFH line 2B, but also to another wired network, and transmits various packets such as MBH packets of an MBH flow from the MBH line 2A and MFH packets of an MFH flow from the MFH line 2B. There is a stronger demand to suppress output delay of the MFH packets than of the MBH packets.

The BBU 6 has a scheduling function for radio sections. The scheduling function is a function to determine various elements such as, for example, user data, a code rate, and a modulation scheme, to be transmitted to one sub-frame. The BBU 6 divides user data into L2 frames and transmits MFH packets to the RRH 5. For example, the BBU 6 transmits the MFH packets to the RRH 5 at sub-frame intervals, for example, every 0.25 milliseconds. Note that, in an MFH radio layer, data packets are transmitted on a fixed size (transmission time interval (TTI) sub-frame. Thus, since the data packets are moved forward from the head per sub-frame, the data packets have the same periodicity as that of the sub-frame. In a fifth generation mobile communication (5G) network, a period of a sub-frame is, for example, 0.25 milliseconds. Furthermore, the RRH 5 divides user data in received radio signals into L2 frames, and transmits MFH packets to the BBU 6.

The backbone line 2C is a line that arranges a plurality of packet switches 7 and transmits MBH packets from the MBH line 2A or MFH packets from the MFH line 2B. Moreover, the packet switches 7 transmit not only MBH packets and MFH packets, but also various other packets. The packet switches 7 apply a time aware shaper (TAS) scheme of the IEEE 802.1Qbv and output MFH packets as high priority packets of a high priority flow. It is assumed that the packet switches 7 incorporate a plurality of packet processing apparatuses 10.

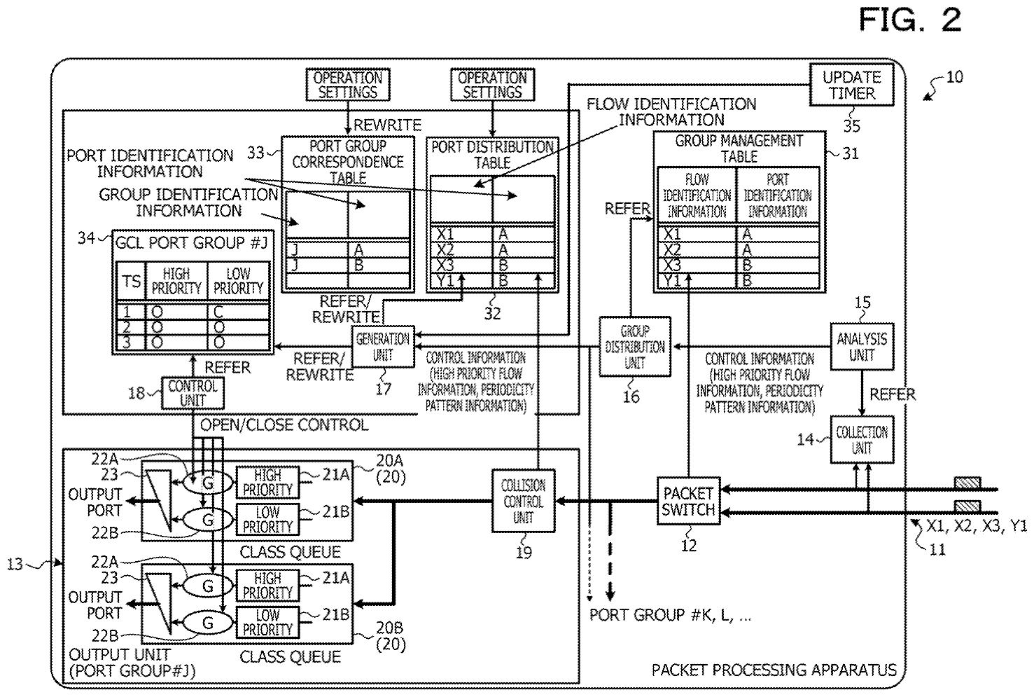

FIG. 2 is an explanatory diagram illustrating an example of a configuration of the packet processing apparatus 10 of the first embodiment. The packet processing apparatus 10 illustrated in FIG. 2 includes an input unit 11, a packet switch 12, and an output unit 13. The input unit 11 includes, for example, four input ports 11A. The packet switch 12 distributes each flow from the input ports 11A to the output unit 13 of each group. Note that the flow is, for example, a high priority flow or a low priority flow.

It is assumed that the output unit 13 is prepared for each group of link aggregation (LAG) described later. The output unit 13 includes an output port 20A (20) of #A and an output port 20B (20) of #B. Each output port 20 includes a first queue 21A, a second queue 21B, a first gate 22A, a second gate 22B, and a selector 23. The first queue 21A is a storage unit that temporarily accumulates high priority packets of a high priority flow. The second queue 21B is a storage unit that temporarily accumulates low priority packets of a low priority flow. The first gate 22A is a gate that opens/closes output of high priority packets being accumulated in the first queue 21A. The second gate 22B is a gate that opens/closes output of low priority packets being accumulated in the second queue 21B. The selector 23 selectively outputs output of the first gate 22A or the second gate 22B. Note that, while MFH packets are high priority packets, non-MFH packets such as MBH packets are low priority packets. As a result, by preferentially outputting the MFH packets, the packet processing apparatuses 10 may suppress output delay of the MFH packets while avoiding contention with the non-MFH packets.

The packet processing apparatus 10 includes a collection unit 14, an analysis unit 15, a group distribution unit 16, a generation unit 17, a control unit 18, a collision control unit 19, and an update timer 35. Moreover, the packet processing apparatus 10 includes a group management table 31, a port distribution table 32, a port group correspondence table 33, and a gate control list (GCL) 34.

The collection unit 14 collects statistical information regarding high priority packets in a high priority flow. The statistical information is a received packet amount of the high priority flow for each time slot (TS). Note that the packet amount is, for example, the number of packets or the number of bytes. Moreover, the collection unit 14 collects flow identification information from control information of a reception flow. The flow identification information is information that identifies a high priority flow, for example, an identification number. The analysis unit 15 analyzes statistical information regarding high priority packets of a high priority flow, and specifies a periodicity pattern such as periodicity and a pattern of the high priority packets. The analysis unit 15 learns an arrival interval (periodicity) and a pattern (average arrival amount and degree of burst fluctuations) of the high priority packets. The analysis unit 15 specifies a periodicity pattern for each piece of the flow identification information that identifies the high priority flow.

The group management table 31 is a table that manages group identification information that identifies a group of the output unit 13 to which the high priority flow is distributed for each piece of the flow identification information of the high priority flow. The flow identification information is, for example, information that identifies a high priority flow X1, X2, or X3 or a low priority flow Y1. The group identification information is information that identifies a group of the output unit 13.

The port distribution table 32 is a table that manages port identification information that identifies the output port 20 as a distribution destination for each piece of flow identification information that identifies a flow. The port identification information is information that identifies the output port 20 as a distribution destination. Note that contents of the port distribution table 32 are updated by operation settings such as operator settings or learning settings.

The port group correspondence table 33 is a table that manages, for each piece of group identification information that identifies a group assigned to the output unit 13, port identification information that identifies each output port 20 in the corresponding output unit 13 of the group.

The GCL 34 is a list that is prepared for each output port 20 of each output unit 13 and that manages opening/closing information of the first gate 22A and the second gate 22B for each TS. The TS is a number that identifies a time slot (TS) of a received packet. The opening/closing information of the first gate 22A is information that controls opening/closing of a gate indicating an open (O)/close (C) state of the first gate 22A. The opening/closing information of the second gate 22B is information that controls opening/closing of a gate indicating an open/close state of the second gate 22B. The TS may be changed as appropriate within the range of 1 to N.

In a case where flow identification information of a reception flow is acquired from the analysis unit 15, the group distribution unit 16 refers to the group management table 31 and acquires group identification information corresponding to the flow identification information of the reception flow. In a case where flow identification information of a reception flow is acquired, the packet switch 12 refers to the group management table 31, specifies group identification information corresponding to the flow identification information of the reception flow, and outputs the reception flow to the output unit 13 of a group corresponding to the group identification information.

In a case where flow identification information of a reception flow is acquired from the group distribution unit 16, the generation unit 17 refers to the port distribution table 32 and specifies port identification information corresponding to the flow identification information. Moreover, the generation unit 17 refers to the port group correspondence table 33 and specifies group identification information corresponding to the port identification information. The generation unit 17 generates opening/closing information of the first gate 22A and the second gate 22B for each TS on the basis of a periodicity pattern of a high priority flow as opening/closing information in the GCL 34 corresponding to the specified group identification information.

The control unit 18 controls opening/closing of the first gate 22A and the second gate 22B in each output port 20 in the output unit 13 corresponding to group identification information on the basis of the GCL 34 corresponding to the group identification information. The collision control unit 19 is a control unit that suppresses a collision of high priority packets in which arrival timings of high priority packets overlap between high priority flows in the same group.

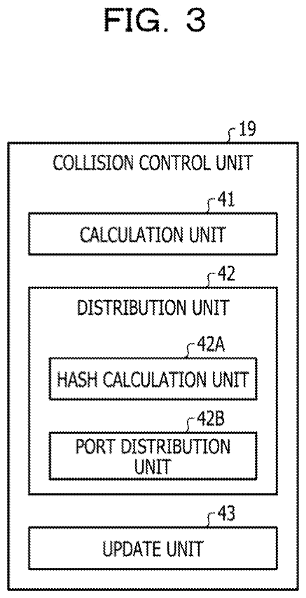

FIG. 3 is a block diagram illustrating an example of a configuration of the collision control unit 19. The collision control unit 19 illustrated in FIG. 3 includes a calculation unit 41, a distribution unit 42, and an update unit 43. The calculation unit 41 calculates a transmission schedule of high priority packets between high priority flows for each output port 20 in the same group. The calculation unit 41 calculates, on the basis of the transmission schedule of each output port 20, the theoretical number of collisions of high priority packets in which arrival timings of high priority packets overlap between high priority flows for each output port 20 in the same group. The distribution unit 42 distributes a high priority packet of a collision to another output port 20 in the same group by the link aggregation (LAG) scheme such that the theoretical number of collisions calculated by the calculation unit 41 is reduced. The distribution unit 42 includes a hash calculation unit 42A and a port distribution unit 42B. The hash calculation unit 42A performs hash calculation by a mod2 operation of a media access control (MAC) address of a terminal device that transmits a high priority flow by adopting an output port distribution technology of the LAG in order to avoid a collision of high priority packets. A hash calculation result is a value that distributes each high priority flow to each output port in the same group. The port distribution unit 42B selects the output port 20 as a distribution destination on the basis of a calculation result of the hash calculation unit 42A. The port distribution unit 42B distributes a high priority flow of a collision to the selected output port 20 in the same group.

The update unit 43 updates contents of the port distribution table 32 according to distribution contents of the distribution unit 42. Note that the distribution contents are distribution contents of each high priority flow for each output port when a high priority flow of a collision is distributed to the output port 20 by the distribution unit 42. Moreover, the update unit 43 generates opening/closing information of each output port 20 in the same group according to the distribution contents of the distribution unit 42, and updates contents of the GCL 34 as the generated opening/closing information.

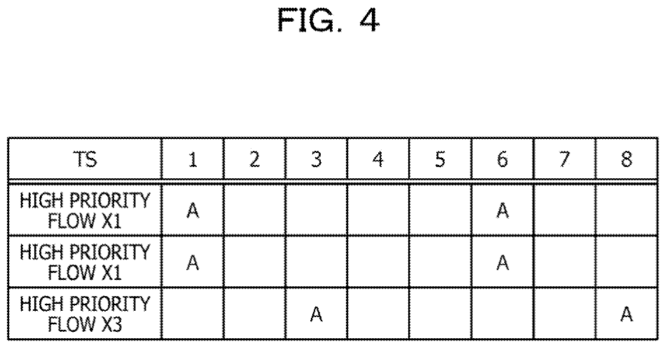

FIG. 4 is an explanatory diagram illustrating an example of statistical information regarding a high priority flow. The collection unit 14 collects statistical information regarding each high priority flow. For example, in statistical information regarding the high priority flow X1, high priority packets are generated at timings of TSs “1” and “6”. Also in statistical information regarding the high priority flow X2, high priority packets are generated at the timings of the TSs “1” and “6”. In statistical information regarding the high priority flow X3, high priority packets are generated at timings of TSs “3” and “8”. For example, in the high priority flows X1 and X2, collision delay occurs at the same timings of the TSs “1” and “6”.

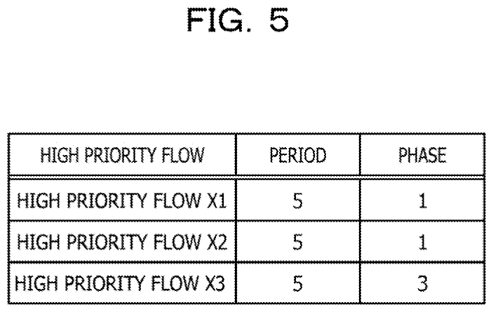

FIG. 5 is an explanatory diagram illustrating an example of a periodicity pattern of the high priority flow. The analysis unit 15 specifies a periodicity pattern, which is a period and a phase of each high priority flow, on the basis of the statistical information regarding the high priority flow illustrated in FIG. 4. For example, in the high priority flow X1, since high priority packets are generated at the timings of the TSs “1” and “6”, the period is “5” and the phase is the start TS “1” of the period. Also in the high priority flow X2, since high priority packets are generated at the timings of the TSs “1” and “6”, the period is “5” and the phase is “1” as in the high priority flow X1. In the high priority flow X3, since high priority packets are generated at the timings of the TSs “3” and “8”, the period is “5” and the phase is “3”.

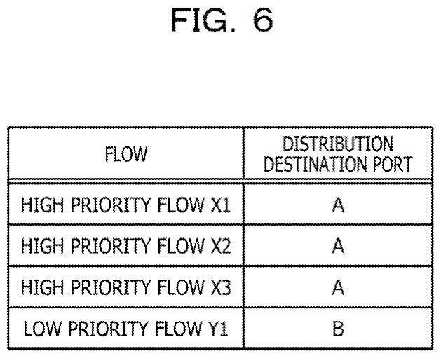

FIG. 6 is an explanatory diagram illustrating an example of table contents of the port distribution table 32. The port distribution table 32 illustrated in FIG. 6 manages the output port 20A of #A as a distribution destination port of the high priority flow X1 and the output port 20A of #A as a distribution destination port of the high priority flow X2. Moreover, the port distribution table 32 manages the output port 20A of #A as a distribution destination port of the high priority flow X3 and the output port 20B of #B as a distribution destination port of the low priority flow Y1.

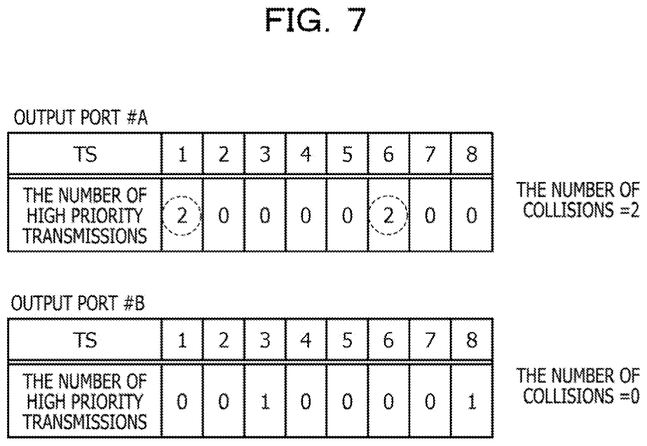

FIG. 7 is an explanatory diagram illustrating an example of the theoretical number of collisions per output port. Note that, for convenience of description, it is assumed that the high priority flows X1 and X2 are distributed to the output port 20A of #A, and the high priority flow X3 is distributed to the output port 20B of #B. The calculation unit 41 calculates the theoretical number of collisions of high priority packets of each TS at the output port 20A of #A on the basis of a transmission schedule (the number of high priority transmissions) of the high priority flow of the output port 20A of #A. The theoretical number of collisions at the output port 20A of #A is 2. The calculation unit 41 calculates the theoretical number of collisions of high priority packets of each TS at the output port 20B of #B on the basis of a transmission schedule (the number of high priority transmissions) of the high priority flow of the output port 20B of #B. The theoretical number of collisions at the output port 20B of #B is 0.

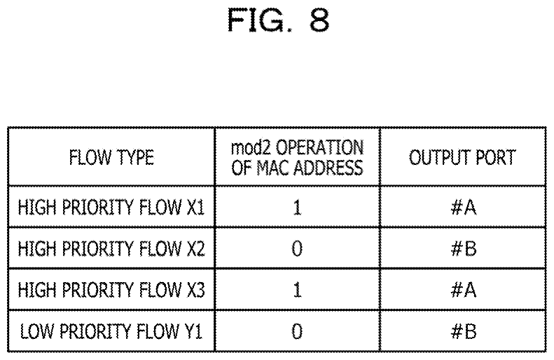

FIG. 8 is an explanatory diagram illustrating an example of port distribution based on a hash calculation result. It is assumed that a MAC address of a terminal device that transmits the high priority flow X1 is 0x00:00:00:00:00:01, and a MAC address of a terminal device that transmits the high priority flow X2 is 0x00:00:00:00:00:02. It is assumed that a MAC address of a terminal device that transmits the high priority flow X3 is 0x00:00:00:00:00:03, and a MAC address of a terminal device that transmits the low priority flow Y1 is 0x00:00:00:00:00:04. Thus, it is assumed that, in a case where a calculation result by the hash calculation unit 42A is “1”, the reception flow is distributed to the output port 20A of #A, and in a case where the calculation result is “0”, the reception flow is distributed to the output port 20B of #B.

In the case of the high priority flow X1, the calculation result of the mod2 operation of the MAC address by the hash calculation unit 42A is “1”. As a result, the port distribution unit 42B selects the output port 20A of #A with the calculation result “1” as a distribution destination, and distributes the high priority flow X1 to the output port 20A of #A. In the case of the high priority flow X2, the calculation result of the mod2 operation of the MAC address by the hash calculation unit 42A is “0”. As a result, the port distribution unit 42B selects the output port 20B of #B with the calculation result “0” as a distribution destination, and distributes the high priority flow X2 to the output port 20B of #B. In the case of the high priority flow X3, the calculation result of the mod2 operation of the MAC address by the hash calculation unit 42A is “1”. As a result, the port distribution unit 42B selects the output port 20A of #A with the calculation result “1” as a distribution destination, and distributes the high priority flow X3 to the output port 20A of #A. In the case of the low priority flow Y1, the calculation result of the mod2 operation of the MAC address by the hash calculation unit 42A is “0”. As a result, the port distribution unit 42B selects the output port 20B of #B with the calculation result “0” as a distribution destination, and distributes the low priority flow Y1 to the output port 20B of #B.

The calculation unit 41 calculates the theoretical number of collisions at each output port 20 in the same group. In a case where the theoretical number of collisions at each output port 20 is one or more, the distribution unit 42 distributes a high priority flow of a collision to each output port 20 so that the theoretical number of collisions is reduced. For example, in a case where the number of collisions in the high priority flows X1 and X2 at the output port 20A of #A is two of the TSs “1” and “6”, the distribution unit 42 distributes the high priority flow X2 of the collision to the output port 20B of #B.

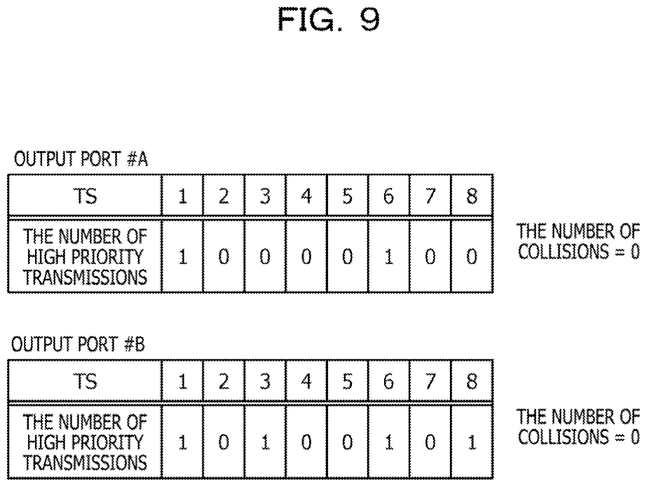

FIG. 9 is an explanatory diagram illustrating an example of the theoretical number of collisions at each output port 20 after the distribution. Since the output port 20A of #A after the distribution has only the high priority flow X1, the theoretical number of collisions at the output port 20A of #A after the distribution is 0. Furthermore, since the output port 20B of #B after the distribution has the high priority flows X2 and X3, the theoretical number of collisions at the output port 20B of #B after the distribution is 0. As a result, there is no collision delay at the output ports 20 of #A and #B.

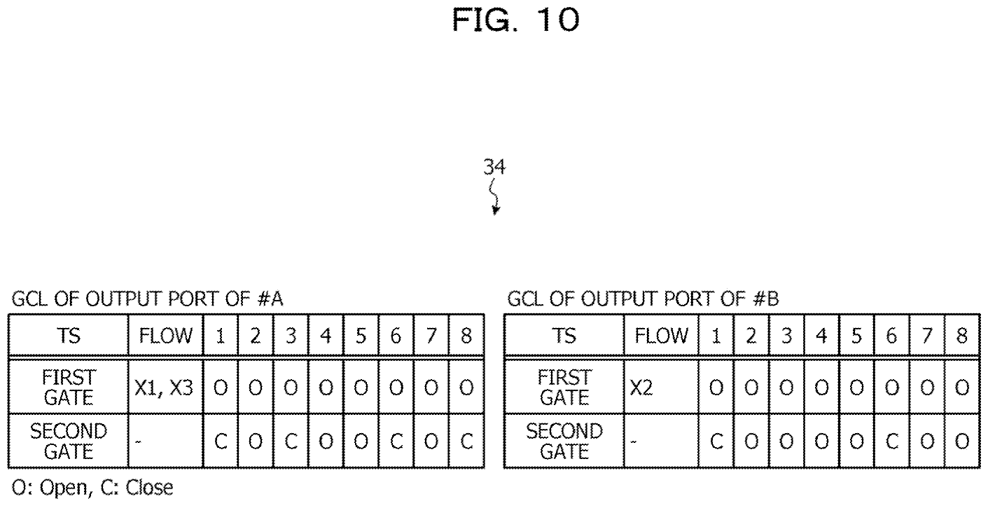

FIG. 10 is an explanatory diagram illustrating an example of the GCL 34 of each output port 20 reflecting distribution contents. The update unit 43 updates, on the basis of the distribution contents of the distribution unit 42, the GCLs 34 of the output ports 20 of #A and #B, to which each high priority flow of the output ports 20 of #A and #B is distributed. The GCL 34 of the output port 20A of #A stores opening/closing information of the first gate 22A and the second gate 22B in a case where the high priority flows X1 and X3 are distributed. The GCL 34 of the output port 20B of #B stores opening/closing information of the first gate 22A and the second gate 22B in a case where the high priority flow X2 is distributed.

The GCL 34 of the output port 20A of #A illustrated in FIG. 10 manages opening/closing information that controls opening of timings of TSs “1” to “8” of the first gate 22A passing through the high priority flows X1 and X3. Moreover, the GCL 34 of the output port 20A of #A manages opening/closing information that controls closing of timings of TSs “1”, “3”, “6”, and “8” of the second gate 22B and controls opening of timings of TSs “2”, “4”, “5”, and “7”. For example, the selector 23 selects and outputs high priority packets of the high priority flows X1 and X3 at the timings of the TSs “1”, “3”, “6”, and “8”.

Moreover, the GCL 34 of the output port 20B of #B manages opening/closing information that controls opening of the timings of the TSs “1” to “8” of the first gate 22A passing through the high priority flow X2. Moreover, the GCL 34 of the output port 20B of #B manages opening/closing information that controls closing of the timings of the TSs “1” and “6” of the second gate 22B and controls opening of the timings of the TSs “2” to “5”, “7”, and “8”. For example, the selector 23 selects and outputs high priority packet of the high priority flow X2 at the timings of the TSs “1” and “6”. As a result, even in a case where arrival timings of high priority flows overlap, it is possible to avoid collision delay between the high priority packets.

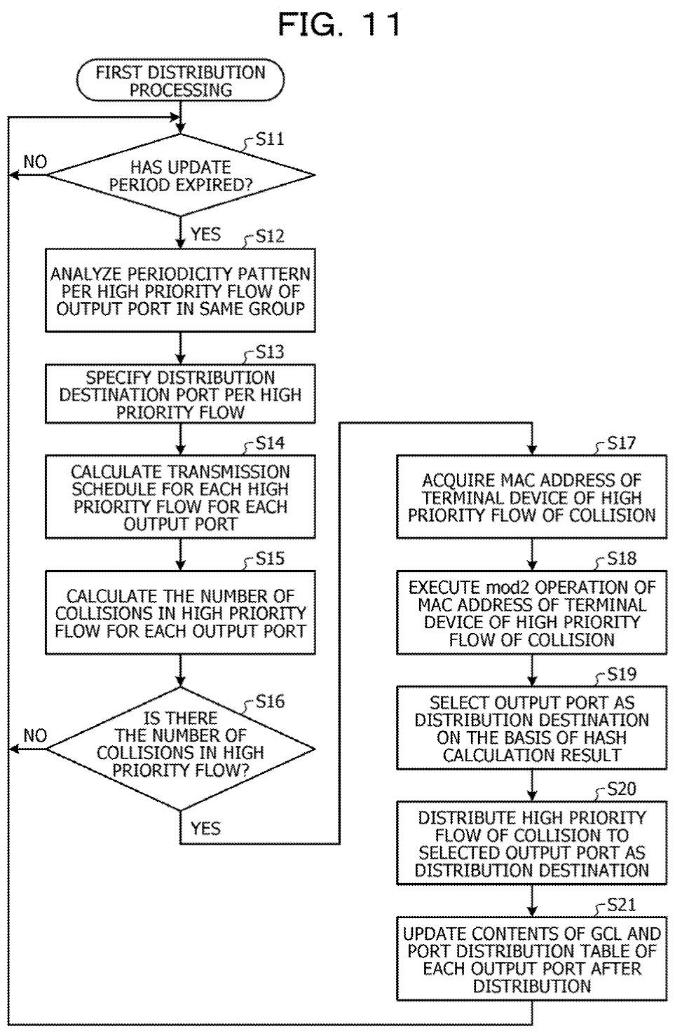

FIG. 11 is a flowchart illustrating an example of a processing operation of the packet processing apparatus 10 related to first distribution processing. In FIG. 11, the update timer 35 of the packet processing apparatus 10 determines whether or not an update period has expired (Step S11). Note that the update timer 35 sequentially monitors the update period from the TSs “1” to “8” as illustrated in FIG. 10, for example. In a case where the update period has expired (Step S11: Yes), the analysis unit 15 in the packet processing apparatus 10 analyzes a periodicity pattern per high priority flow of each output port 20 in the same group (Step S12).

The group distribution unit 16 in the packet processing apparatus 10 refers to the group management table 31 and specifies the output port 20 as a distribution destination per high priority flow corresponding to the group (Step S13). The calculation unit 41 in the collision control unit 19 in the packet processing apparatuses 10 calculates a transmission schedule for each high priority flow for each output port 20 in the same group (Step S14). Moreover, the calculation unit 41 calculates, on the basis of the transmission schedule, the theoretical number of collisions in a high priority flow for each output port 20 in the same group (Step S15).

The distribution unit 42 in the collision control unit 19 determines whether or not there is the theoretical number of collisions in the high priority flow (Step S16). In a case where there is the theoretical number of collisions in the high priority flow (Step S16: Yes), the hash calculation unit 42A in the distribution unit 42 acquires a MAC address of a terminal device of the high priority flow of the collision of the output port 20 having the theoretical number of collisions (Step S17).

The hash calculation unit 42A executes a mod2 operation of the MAC address of the terminal device of the high priority flow of the collision (Step S18). The port distribution unit 42B in the distribution unit 42 selects the output port 20 as the distribution destination on the basis of a hash calculation result (Step S19). Moreover, the port distribution unit 42B distributes the high priority flow of the collision to the selected output port 20 as the distribution destination (Step S20). The update unit 43 in the collision control unit 19 distributes the high priority flow of the collision to the output port 20, and then updates contents of the GCL 34 and the port distribution table 32 of each output port 20 in the same group on the basis of distribution contents (Step S21). Then, the update timer 35 proceeds to Step S11 to determine whether or not the update period has expired.

In a case where the update period has not expired (Step S11: No), the update timer 35 proceeds to the processing in Step S11. Furthermore, in a case where there is no theoretical number of collisions in the high priority flow (Step S16: No), the update timer 35 proceeds to Step S11 to determine whether or not the update period has expired.

In a case where there is the theoretical number of collisions in the high priority flow, the packet processing apparatus 10 of the first embodiment selects the output port 20 to which the high priority flow of the collision is distributed on the basis of the calculation result of the mod2 operation of the MAC address of the high priority flow of the collision. The packet processing apparatuses 10 distributes the high priority flow of the collision to the selected output port 20. Then, the packet processing apparatus 10 updates the contents of the GCL 34 and the port distribution table 32 of each output port 20 according to the distribution contents of the high priority flow. As a result, the packet processing apparatus 10 may suppress collision delay of high priority packets even in a case where arrival timings of the high priority packets overlap between high priority flows.

Note that the hash calculation unit 42A of the first embodiment exemplifies, for example, the mod2 operation, but the embodiment is not limited to this, and may be changed as appropriate.

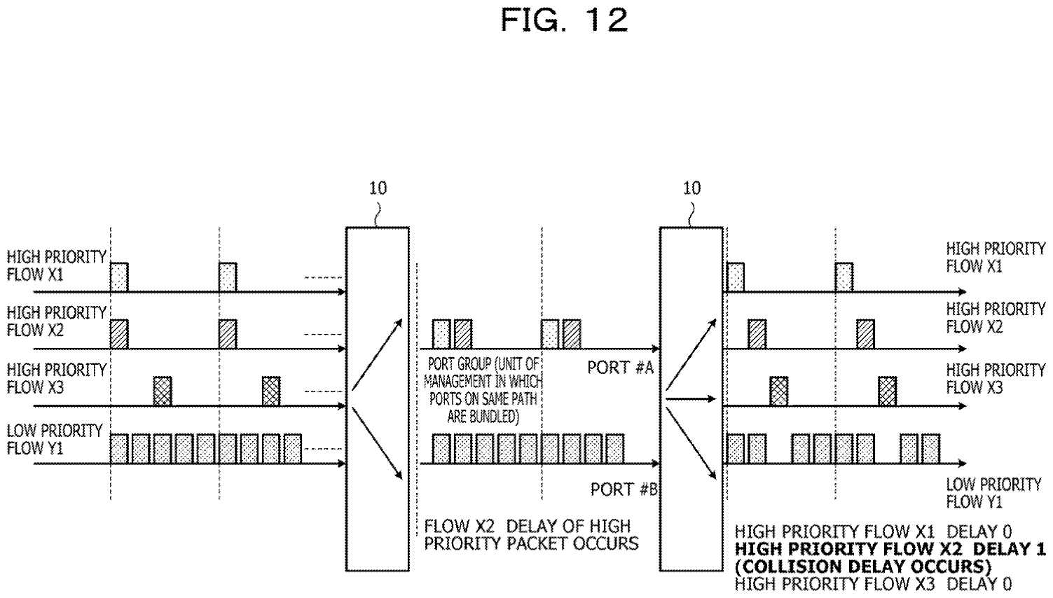

FIG. 12 is an explanatory diagram illustrating an example of a problem of the packet processing apparatus 10 of the first embodiment. The packet processing apparatus 10 sequentially inputs the high priority flows X1, X2, and X3 and the low priority flow Y1. A case has been exemplified where the packet processing apparatus 10 selects the output port 20 of the high priority flow of the collision on the basis of the hash calculation result of the mod2 operation of the MAC address of the terminal device of the high priority flow of the collision, and distributes the high priority flow of the collision to the selected output port 20. However, in the packet processing apparatus 10, since the mod2 operation of the MAC address is adopted as a method of distributing the output port of the high priority flow, the distribution destination of the high priority flow of the collision depends on the MAC address of the terminal device that transmits the high priority flow of the collision. As a result, it is conceivable that a case occurs where high priority packets to be collided are distributed to the same output port 20 depending on the MAC address.

It is assumed that the MAC address of the terminal device that transmits the high priority flow X1 is 0x00:00:00:00:00:01, and the MAC address of the terminal device that transmits the high priority flow X2 is 0x00:00:00:00:00:03. It is assumed that the MAC address of the terminal device that transmits the high priority flow X3 is 0x00:00:00:00:00:02, and the MAC address of the terminal device that transmits the low priority flow Y1 is 0x00:00:00:00:00:04. For example, in a case where arrival timings of the high priority flows X1 and X2 at the output port 20A of #A overlap and the MAC address of the terminal device that transmits the high priority flow X2 is 0x00:00:00:00:00:03, the calculation result of the hash calculation unit 42A is “1”. In a case where the calculation result is “1”, the high priority flow X2 is distributed to the output port 20A of #A again.

Then, on the basis of the hash calculation result of the high priority flow of the collision, the packet processing apparatus 10 distributes the high priority flows X1 and X2 to the output port 20A of #A, and distributes the high priority flow X3 and the low priority flow Y1 to the output port 20B of #B. For example, in the packet processing apparatus 10, even after the hash calculation, since the high priority flows X1 and X2 are again distributed to the output port 20A of #A and collision occurs at the arrival timing of the TS “1”, collision delay occurs in the high priority flow X2.

Therefore, a packet processing apparatus 10A capable of suppressing collision delay in a high priority flow even in a case where arrival timings of high priority packets overlap between high priority flows without depending on a MAC address of a terminal device of the high priority flow will be described as a second embodiment.

### Second Embodiment

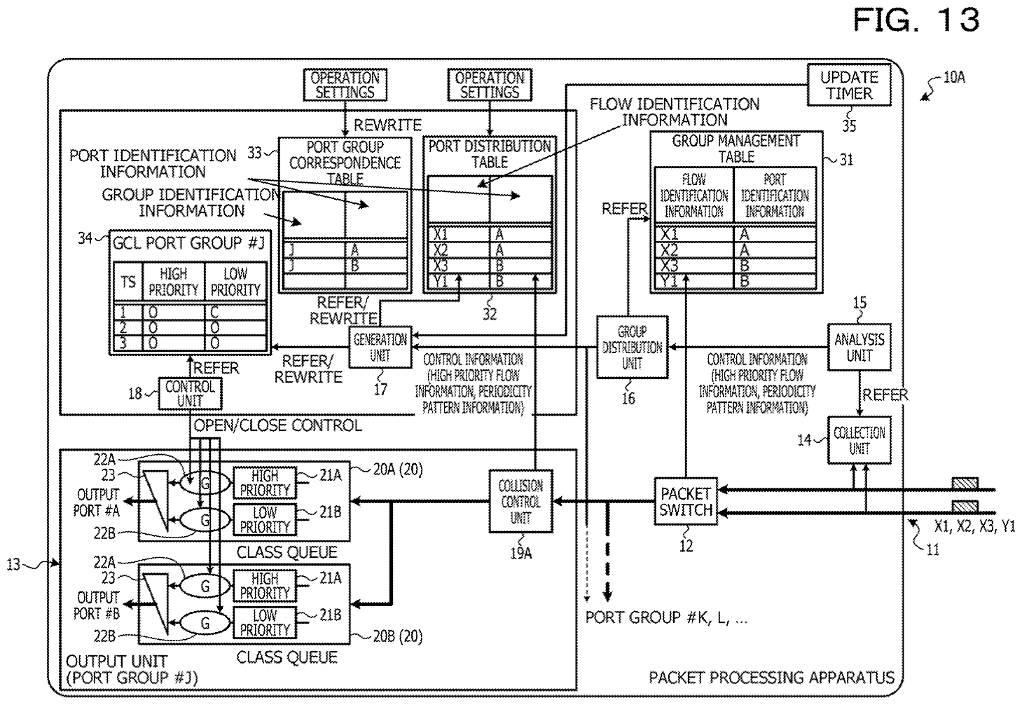

FIG. 13 is an explanatory diagram illustrating an example of a configuration of the packet processing apparatus 10A of the second embodiment. Note that a difference between the packet processing apparatus 10 of the first embodiment and the packet processing apparatus 10A of the second embodiment is that a collision control unit 19A is arranged instead of the collision control unit 19. The collision control unit 19A is a control unit that suppresses collision delay in a high priority flow by distributing a high priority flow of a collision to another output port 20 in the same group without using hash calculation using a MAC address of a terminal device that transmits a high priority flow.

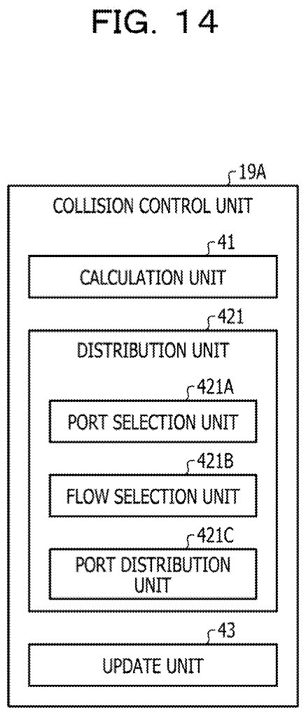

FIG. 14 is an explanatory diagram illustrating an example of a configuration of the collision control unit 19A. The collision control unit 19A illustrated in FIG. 14 includes a calculation unit 41, a distribution unit 421, and an update unit 43. The distribution unit 421 includes a port selection unit 421A, a flow selection unit 421B, and a port distribution unit 421C.

The port selection unit 421A selects an output port 20 having the largest theoretical number of collisions among the theoretical numbers of collisions at the respective output ports 20 in the same group. The flow selection unit 421B selects a high priority flow of a collision to be distributed from an output port 20 selected by the port selection unit 421A. Note that, in a case where there is a plurality of high priority flows of collisions to be distributed, the flow selection unit 421B selects a high priority flow whose number serving as flow identification information that identifies a high priority flow is in descending order.

The port distribution unit 421C distributes a high priority flow of a collision selected by the flow selection unit 421B to another output port 20 in the same group. The update unit 43 compares the theoretical number of collisions at the output port 20 before the distribution in the port distribution unit 421C with the theoretical number of collisions at the output port 20 after the distribution in the port distribution unit 421C. In a case where the theoretical number of collisions at the output port 20 after the distribution is less than the theoretical number of collisions at the output port 20 before the distribution, the update unit 43 updates contents of a GCL 34 and a port distribution table 32 according to distribution contents of the output port 20 after the distribution.

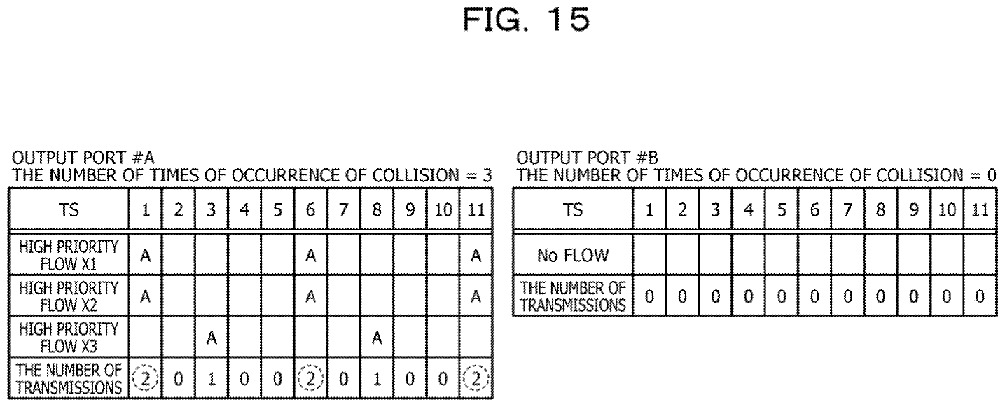

The calculation unit 41 calculates the theoretical number of collisions at an output port 20A of #A in the same group in TSs “1” to “11” on the basis of a transmission schedule of a high priority flow. FIG. 15 is an explanatory diagram illustrating an example of the theoretical number of collisions per output port. Note that, for convenience of description, it is assumed that arrival timings of high priority flows X1 and X2 are TSs “1”, “6”, and “11”, and arrival timings of a high priority flow X3 are TSs “3” and “8”. Moreover, it is assumed that a distribution destination of the high priority flows X1, X2, and X3 is the output port 20A of #A. In this case, the theoretical number of collisions at the output port 20A of #A is 3, whereas the theoretical number of collisions at an output port 20B of #B is 0.

The port selection unit 421A selects an output port 20 having the largest theoretical number of collisions among the theoretical numbers of collisions at the respective output ports 20 in the same group. For example, the port selection unit 421A selects the output port 20A of #A having the largest theoretical number of collisions, as illustrated in FIG. 15. The flow selection unit 421B selects the high priority flow X2 of the collision to be distributed from the output port 20A of #A selected by the port selection unit 421A. Note that, in a case where there is a plurality of high priority flows of collisions to be distributed, the flow selection unit 421B selects the high priority flow X2 in descending order. In a case where there are the high priority flows X1 and X2 of the collisions to be distributed as illustrated in FIG. 15, the flow selection unit 421B selects the high priority flow X2 in descending order as the high priority flow to be distributed.

The port distribution unit 421C distributes the high priority flow X2 of the collision selected by the flow selection unit 421B to another output port 20 in the same group, for example, to the output port 20B of #B. The update unit 43 compares the theoretical number of collisions at the output port 20A of #A before the distribution in the port distribution unit 421C with the theoretical number of collisions at the output port 20A of #A after the distribution in the port distribution unit 421C.

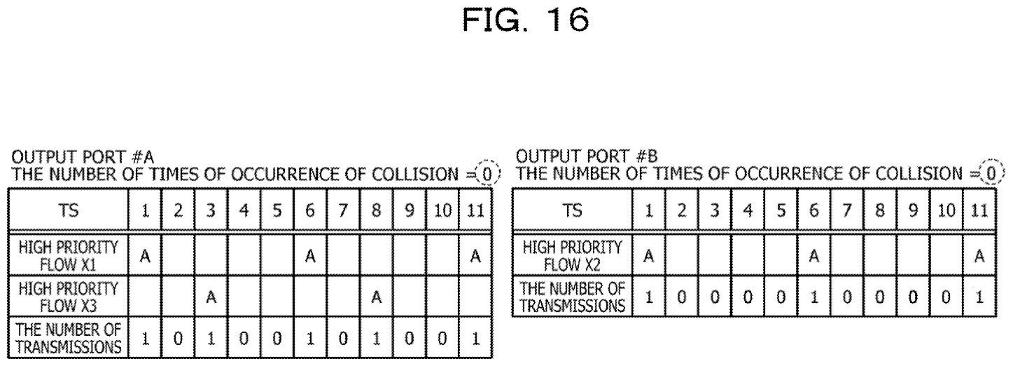

FIG. 16 is an explanatory diagram illustrating an example of the theoretical number of collisions at the output port 20 after the distribution. Since the output port 20A of #A after the distribution has the high priority flows X1 and X3, the theoretical number of collisions at the output port 20A of #A after the distribution is 0. Furthermore, since the output port 20B of #B after the distribution has the high priority flow X2, the theoretical number of collisions at the output port 20B of #B after the distribution is 0. As a result, there is no collision delay at the output ports 20 of #A and #B.

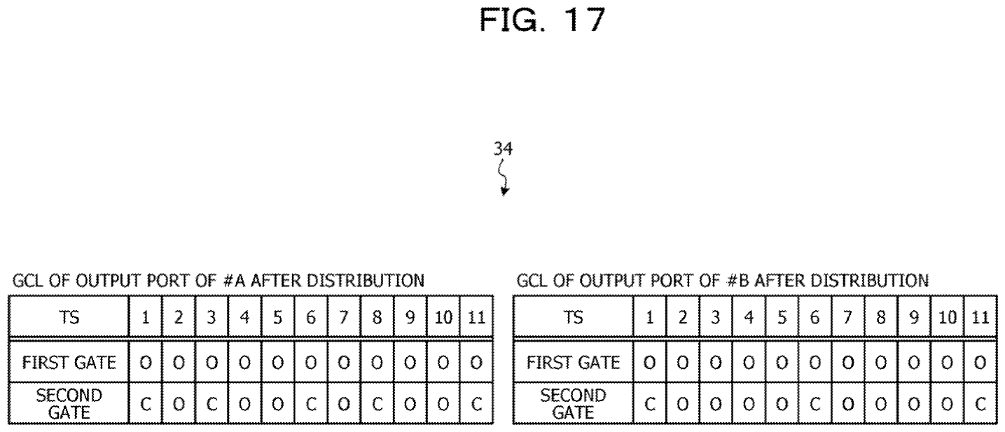

In a case where the number of collisions at the output port 20A of #A after the distribution is less than the number of collisions at the output port 20A of #A before the distribution, the update unit 43 updates the GCL 34 according to distribution contents of the output port 20 after the distribution. FIG. 17 is an explanatory diagram illustrating an example of the GCL 34 of each output port 20 reflecting the distribution contents. For example, the update unit 43 updates, on the basis of the distribution contents of the distribution unit 421, the GCLs 34 of the output ports 20 of #A and #B, to which the high priority flows of the output ports 20 of #A and #B are distributed. The GCL 34 of the output port 20A of #A stores opening/closing information of the first gate 22A and the second gate 22B in a case where the high priority flows X1 and X3 are distributed. The GCL 34 of the output port 20B of #B stores opening/closing information of the first gate 22A and the second gate 22B in a case where the high priority flow X2 is distributed.

As illustrated in FIG. 17, the GCL 34 of the output port 20A of #A after the distribution manages opening/closing information that controls opening of timings of TSs “1” to “11” of the first gate 22A passing through the high priority flows X1 and X3. The GCL 34 of the output port 20A of #A manages opening/closing information that controls closing of timings of TSs “1”, “3”, “6”, “8”, and “11” of the second gate 22B and controls opening of timings of TSs “2”, “4”, “5”, “7”, “9”, and “10”. For example, a selector 23 selects and outputs high priority packets of the high priority flows X1 and X3 at the timings of the TSs “1”, “3”, “6”, “8”, and “11”.

The GCL 34 of the output port 20B of #B after the distribution manages opening/closing information that controls opening of the timings of the TSs “1” to “11” of the first gate 22A passing through the high priority flow X2. Moreover, the GCL 34 of the output port 20B of #B manages opening/closing information that controls closing of the timings of the TSs “1”, “6”, and “11” of the second gate 22B and controls opening of the timings of the TSs “2” to “5” and “7” to “10”. For example, the selector 23 selects and outputs high priority packet of the high priority flow X2 at the timings of the TSs “1”, “6”, and “11”. As a result, even in a case where arrival timings of high priority flows overlap, it is possible to avoid collision delay between the high priority packets.

Moreover, the update unit 43 updates the contents of the port distribution table 32 by associating the high priority flows X1 and X3 with the output port 20A of #A to distribute the high priority flows X1 and X3 to the output port 20A of #A. Moreover, the update unit 43 updates the contents of the port distribution table 32 by associating the high priority flow X2 and the low priority flow Y1 with the output port 20B of #B to distribute the high priority flow X2 and the low priority flow Y1 to the output port 20B of #B.

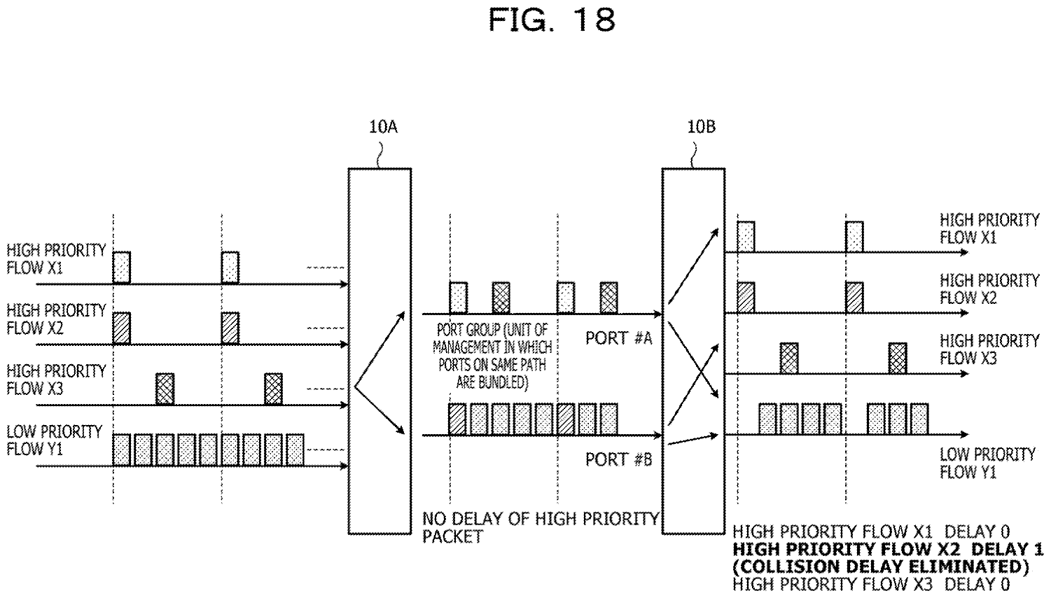

FIG. 18 is an explanatory diagram illustrating an example of packet output of the packet processing apparatus 10A of the second embodiment. The packet processing apparatus 10A after the distribution illustrated in FIG. 18 outputs the high priority flows X1 and X3 of the output port 20A of #A to an opposite apparatus 10B, and outputs the high priority flow X2 and low priority flow Y1 of the output port 20B of #B to the opposite apparatus 10B. As a result, since the opposite apparatus 10B may output the high priority flow X1 and the high priority flow X2 at the same timing, collision delay in the high priority flow may be suppressed.

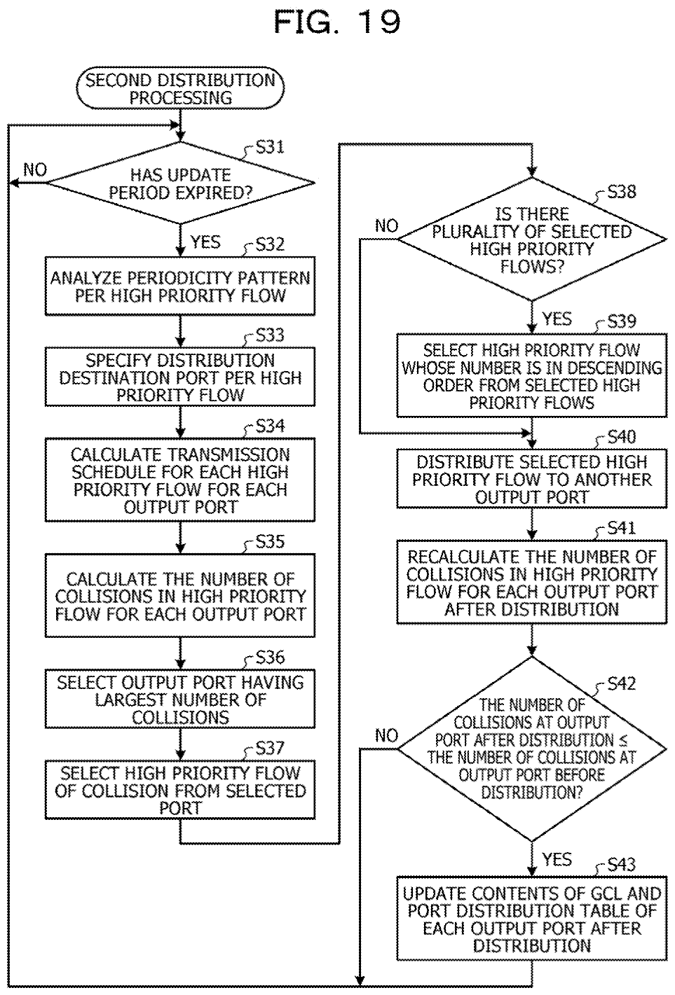

FIG. 19 is a flowchart illustrating an example of a processing operation of the packet processing apparatus 10A related to second distribution processing. In FIG. 19, an update timer 35 of the packet processing apparatus 10A determines whether or not an update period has expired (Step S31). Note that the update timer 35 monitors the update period from the TSs “1” to “11” as illustrated in FIG. 17, for example. In a case where the update period has expired (Step S31: Yes), an analysis unit 15 in the packet processing apparatus 10A analyzes a periodicity pattern per high priority flow of each output port 20 in the same group (Step S32).

A group distribution unit 16 in the packet processing apparatus 10A refers to a group management table 31 and specifies the output port 20 as a distribution destination per high priority flow corresponding to the group (Step S33). The calculation unit 41 in the collision control unit 19A in the packet processing apparatus 10A calculates a transmission schedule for each high priority flow for each output port 20 in the same group (Step S34). Moreover, the calculation unit 41 calculates the theoretical number of collisions in a high priority flow for each output port 20 in the same group (Step S35).

The port selection unit 421A in the distribution unit 421 selects an output port having the largest theoretical number of collisions among the output ports 20 in the same group (Step S36). The flow selection unit 421B in the distribution unit 421 selects a high priority flow of a collision from the selected output port 20 (Step S37).

The flow selection unit 421B determines whether or not there is a plurality of selected high priority flows of the collisions (Step S38). In a case where there is a plurality of high priority flows of the collisions (Step S38: Yes), the flow selection unit 421B selects a high priority flow whose flow identification number serving as flow identification information is in descending order from the plurality of high priority flows of the collisions (Step S39).

Moreover, the port distribution unit 421C distributes the selected high priority flow to another output port 20 in the same group (Step S40). The calculation unit 41 recalculates, on the basis of a transmission schedule of the high priority flow after the distribution, the theoretical number of collisions in the high priority flow for each output port 20 after the distribution (Step S41).

The update unit 43 determines whether or not the theoretical number of collisions in the high priority flow of the collision at the output port 20 after the distribution is less than the theoretical number of collisions in the high priority flow of the collision at the output port 20 before the distribution (Step S42). In a case where the number of collisions at the output port 20 after the distribution is less than the number of collisions at the output port 20 before the distribution (Step S42: Yes), the update unit 43 updates contents of the GCL 34 and the port distribution table 32 of each output port 20 in the same group (Step S43). Note that, to distribute the selected high priority flow to the output port 20 after the distribution, the update unit 43 updates the contents of the GCL 34 and the port distribution table 32 of each output port 20 in the same group on the basis of distribution contents. Then, the update timer 35 proceeds to Step S31 to determine whether or not the update period has expired.

In a case where the update period has not expired (Step S31: No), the update timer 35 proceeds to the processing in Step S31. In a case where the theoretical number of collisions in the high priority flow of the collision of the output port 20 after the distribution is not less than the theoretical number of collisions in the high priority flow of the collision of the output port 20 before the distribution (Step S42: No), the update timer 35 proceeds to Step S31.

The packet processing apparatus 10A of the second embodiment selects the output port 20 having the largest theoretical number of collisions in the high priority flow among the output ports 20 in the same group. The packet processing apparatus 10A selects the high priority flow in descending order from the selected high priority flows of the collisions of the output port 20, and distributes the selected high priority flow to another output port 20 in the same group. Then, the packet processing apparatus 10A updates the contents of the GCL 34 and the port distribution table 32 of each output port 20 according to the distribution contents of the high priority flow. As a result, the packet processing apparatus 10 may suppress collision delay of high priority packets without depending on a MAC address even in a case where arrival timings of the high priority packets overlap between high priority flows.

In the embodiments described above, a case where the number of output ports 20 of the output unit 13 is two has been exemplified, but the number is not limited to two, and may be three or more, and the number may be changed as appropriate.

Furthermore, a case has been exemplified where the flow selection unit 421B of the second embodiment selects the high priority flow whose flow identification number is in descending order in a case where there is a plurality of high priority flows of collisions, but a high priority flow whose flow identification number is in ascending order may be selected. Furthermore, it is sufficient that one high priority flow may be selected from a plurality of high priority flows on the basis of a predetermined rule without being limited to the descending order or the ascending order of the flow identification numbers, and the selection method may be changed as appropriate.

In the embodiments described above, there are two types of packets including an MFH packet as a high priority packet and a non-MFH packet as a low priority packet, the types are not limited to the two types, and may be changed as appropriate. For example, in a case where the priority is set to three types of packets, three gates may be arranged and opening/closing information of each gate in the GCL 34 may be stored.

In the embodiments described above, for example, it is assumed that a time width of a sub-frame is 0.25 milliseconds in order to correspond to a radio signal of the 5G network, but the time width is not limited to 0.25 milliseconds, and may be 1 millisecond as a time width of a sub-frame of a radio signal of a fourth generation mobile communication (4G) network, and may be changed as appropriate.

In the embodiments described above, it is assumed that one period of a sub-frame is N TSs, but it is sufficient if periodicity may be maintained, and one period of the sub-frame may be set to a multiple of N, and may be changed as appropriate.

Furthermore, each of the components of each of the units illustrated in the drawings does not necessarily need to be physically configured as illustrated in the drawings. For example, specific forms of separation and integration of each of the units are not limited to the illustrated forms, and all or some of the units may be functionally or physically separated and integrated in any unit according to various loads, use situations, and the like.

Moreover, all or any part of various processing functions executed in each of the devices may be executed by a central processing unit (CPU) (or a microcomputer such as a micro processing unit (MPU) and a micro controller unit (MCU)). Furthermore, all or any part of the various processing functions may of course be executed by a program analyzed and executed by a CPU (or a microcomputer such as an MPU and an MCU) or hardware using wired logic.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A packet processing apparatus comprising:
a plurality of storages configured to store packets for each high priority flow or low priority flow for each output port in the same group;
a gate configured to open and close output of each storage; and
a processor configured to:
control opening and closing of the gate to preferentially output high priority packets of the high priority flow on the basis of gate information that controls the gate;
calculate, for each output port, the theoretical number of collisions of the high priority packets in which arrival timings overlap between the high priority packets;
distribute a high priority flow of a collision to another output port in the same group by a link aggregation scheme such that the theoretical number of collisions is reduced; and
update contents of the gate information based on distribution contents.

2. The packet processing apparatus according to claim 1, wherein
the processor
calculates, when an update timing of the gate information is detected, the theoretical number of collisions of high priority packets in which arrival timings overlap between the high priority packets, for each output port.

3. The packet processing apparatus according to claim 2, wherein
port distribution information that manages an output port as a distribution destination is stored in a storage for each high priority flow, and
the processor
updates, on the basis of the distribution contents, contents of the port distribution information to contents related to the corresponding output port after the distribution associated with the high priority flow after the distribution.

4. The packet processing apparatus according to claim 1, wherein
the processor:
selects an output port that has the maximum calculated number of collisions;
selects a high priority flow of a collision to be distributed from the output port; and
distributes the high priority flow of the collision to another output port in the same group.

5. The packet processing apparatus according to claim 1, wherein
the processor
updates, based on the distribution contents of the output port after the distribution, the contents of the gate information in a case where the theoretical number of collisions at the corresponding output port after the distribution is less than the theoretical number of collisions at the output port before the distribution.

6. A packet processing method comprising:
controlling, by a computer, opening and closing of a gate, which opens and closes output of each of a plurality of storages which store packets for each high priority flow or low priority flow for each output port in the same group, to preferentially output high priority packets of the high priority flow on the basis of gate information that controls the gate;
calculating, for each output port, the theoretical number of collisions of the high priority packets in which arrival timings overlap between the high priority packets;
distributing a high priority flow of a collision to another output port in the same group by a link aggregation scheme such that the theoretical number of collisions is reduced; and
updating contents of the gate information based on distribution contents.
